(19) United States
(12) Patent Application Publication
(10) Pub. No.: US 2012/0090457 A1
(43) Pub. Date: Apr. 19, 2012

(54) ANNULAR SPRING ELEMENT FOR A HYDRAULIC BELT TENSIONER

(75) Inventor: Marco Kowalski, Herzogenaurach (DE)

(73) Assignee: SCHAEFFLER TECHNOLOGIES GMBH & CO. KG, Herzogenaurach (DE)

(21) Appl. No.: 13/378,185

(22) PCT Filed: Jul. 15, 2010
(86) PCT No.: PCT/EP10/60227

§ 371 Date: Dec. 14, 2011

(30) Foreign Application Priority Data
Aug. 20, 2009 (DE) 102009038225.9

(51) Int. Cl. F16H 7/08; F15B 11/10

(52) U.S. Cl. 91/468

(57) ABSTRACT

A hydraulic tensioning system (1) for a belt drive, including a cylinder (4) that is designed to receive a linearly displaceable piston (6), these elements together forming a piston-cylinder unit (3) and delimiting a pressure chamber (10) that is filled with hydraulic fluid. A relative movement between the piston (6) and the cylinder (4) causes the hydraulic fluid to be exchanged between the pressure chamber (10) and a storage chamber (12) or vice versa. At least one annular spring valve (14), which opens depending on the pressure, is positioned in an outflow section (17) for the hydraulic fluid between the pressure chamber (10) and the storage chamber (12) as a one-way valve.

### BACKGROUND

The invention relates to a hydraulic tensioning system of a belt drive, with this system comprising a pot-shaped housing forming a cylinder for holding a linearly displaceable piston, which together form a piston-cylinder unit and delimit a pressure chamber filled with hydraulic fluid, wherein a relative movement between the piston and the cylinder triggers an exchange of the hydraulic fluid from the pressure chamber into a storage chamber or vice versa.

The hydraulic tensioning systems used in belt drives of internal combustion engines must have a quick response, in order to always guarantee sufficient biasing tension and damping in all operating states and in the event of high-frequency belt oscillations. In order to satisfy this demand, the non-return valves integrated in hydraulic tensioning systems must be designed so that, after a compensation of the hydraulic fluid via a leakage gap into the storage chamber, in which damping is generated by the shear forces of the hydraulic fluid, the pressure chamber can be temporarily filled with hydraulic fluid.

From U.S. Pat. No. 4,940,447, a hydraulic tensioning system is known in which, for damping, the hydraulic fluid can be exchanged between a storage chamber and a pressure chamber via a one-way valve or non-return valve. For this tensioning system, a plate-shaped valve body with a central opening is used as the non-return valve. The valve is supported not over its entire surface in the installation state which can lead to an instable position of the valve body, with the risk of developing disadvantageous noise.

The tensioning device according to DE 10 2004 018 566 A1 comprises a one-way valve which is similarly provided with a disk-shaped valve body. The structural configuration includes at least three individual parts that are required for completing the non-return valve and that require a complicated manufacturing process and handling for assembly.

In the known hydraulic tensioning systems, hydraulic fluid is exchanged as a function of the control motion of the piston typically via a one-way valve formed as a ball non-return valve and also in the reverse direction via a leakage gap between the piston and the cylinder. A leakage gap that directly influences the damping of the tensioning system and is arranged between the lateral surface of the piston and the inner wall of the cylinder represents an increased manufacturing expense, in order to realize an installation play for a defined leakage gap.

The damping force to be generated in the hydraulic tensioning system is dependent on the leakage gap size, on the viscosity of the hydraulic fluid, which is influenced by temperature, and on a pulse transmitted, for example, by belt oscillations to the hydraulic tensioning system. In modern tensioning systems, for each application or installation situation of the tensioning system, the damping force range in which the viscosity is taken into account as a function of temperature is fixed and the leakage gap or leakage gap size is produced and assembled during assembly by means of a grouping and measuring device.

### SUMMARY

The present invention is based on the objective of providing an economically manufacturable one-way valve that is optimized with regard to installation space and components for a hydraulic tensioning system.

For meeting this objective, the hydraulic tensioning system according to the invention comprises at least one annular spring element or annular spring valve that opens as a function of pressure and that is used in an outflow path for the hydraulic fluid between the pressure chamber in the piston-cylinder unit and the storage chamber.

The annular spring valve comparable in function with an overpressure valve is designed so that the biasing tension of an annular element closes the valve and creates a seal. Only after a pressure has built up in the pressure chamber that exceeds a restoring force of the annular spring valve does the hydraulic fluid flow via the annular spring valve. Through the use of the annular spring valve according to the invention in a hydraulic tensioning system, the design and cost-intensive production of a defined leakage gap can be advantageously eliminated. In addition to simplified production, a reduced component scope of the hydraulic tensioning system is also set, wherein, as a whole, a cost-optimized hydraulic tensioning system can be provided. Another advantage of the invention is provided in that, in connection with the annular spring valve, a hydraulic tensioning system can be easily adapted optimally to desired operating conditions. In addition, the invention offers the ability of covering a large variety of variants of the hydraulic tensioning systems in use. The annular spring valve according to the invention can be used preferably for cost-optimized tensioning systems.

The design according to the invention allows the hydraulic tensioning system to be adapted in an improved way to the actual demands. The necessary adaptation to actual engine dynamics can be performed easily with the proposed design, which leads to an overall improved operating behavior compared with prior solutions.

Other advantageous constructions of the invention are the subject matter of the dependent claims 2 to 10.

One preferred design of the invention provides that, for forming the annular spring valve, the cylinder has, in the area of the pressure chamber, at least one opening that interacts with a spring element enclosing the cylinder on the outside and biased in the closing direction. The spring element guided on the cylinder on the outside generates, until reaching an opening pressure, an effective seal for the opening and thus prevents a flow or an exchange of hydraulic fluid from the pressure chamber into the storage chamber.

Advantageously, the cylinder includes, in one plane, several openings that are positioned distributed around the periphery and are effectively closed by the spring element in a neutral position of the piston or until reaching an opening pressure.

According to the invention, it is possible to create a hydraulic tensioning system in which the piston-cylinder unit comprises a first annular spring valve designed as a one-way valve and allocated to the outflow path, as well as a second conventional one-way valve designed as a ball valve and allocated to the inflow path.

The spring element of the annular spring element is preferably positioned in an annular groove expanded in a V-shape on the outside of the cylinder. A desired fast responsiveness, i.e., optimal switching hysteresis of the annular filter element, is achieved in that the spring element interacts with several relatively large openings of the cylinder, wherein the hydraulic pressure in the pressure chamber of the piston-cylinder unit impinges on a large surface area of the annular element. An increased depth of the annular groove further improves the switching hysteresis, because an increased control path of the spring element guarantees, in the case of an overpressure of the hydraulic fluid in the pressure chamber, a nearly resistance-free flow of the hydraulic fluid.

As the spring element, advantageously a radially biased snap ring is suitable that is preferably produced from a round spring wire. The invention is not restricted to one cross-sectional profile for the spring wire, but instead also includes, for example, a square or rectangular cross-sectional profile.

According to the invention it is also possible that the opening of the cylinder interacts on the outside with a spring element produced from plastic. For this purpose, a material is selected that fulfills all of the requirements with regard to durability and function for achieving a sufficient service life of the hydraulic tensioning system.

One preferred structural design of the invention provides that the outflow path for the hydraulic fluid is designed as a channel that connects the annular groove of the cylinder for holding the spring element to the storage chamber that is delimited radially by a housing enclosing the piston-cylinder unit with spacing and the cylinder of the piston-cylinder unit. The outflow path for the hydraulic fluid can be formed, for example, as a concentric drilled hole for the piston in the piston-cylinder unit.

As a measure for guaranteeing a durable function of the annular spring valve according to the invention, the spring element with a slit is inserted oriented in position. For this purpose, for example, a radially projecting centering tab that is allocated to the cylinder and engages with a positive fit in the slit of the spring element is suitable and thus guarantees a defined installation position of the spring element in which all of the openings in the cylinder are covered in a sealing manner.

### BRIEF DESCRIPTION OF THE DRAWINGS

A preferred embodiment of the invention is shown in the drawings that are described in more detail below. Shown are:

FIG. 1 is an enlarged representation of a piston-cylinder unit of a hydraulic tensioning system in connection with an annular spring valve according to the invention;

FIG. 2 the cylinder of the piston-cylinder unit as an individual part;

FIG. 3 a spring element of the annular spring valve as an individual part;

FIG. 4 a section view of a hydraulic tensioning system of known construction.

### DETAILED DESCRIPTION OF THE PREFERRED EMBODIMENTS

The description of a known hydraulic tensioning system 1 follows according to FIG. 4. The design of the tensioning system 1 comprises a pot-shaped housing 2 in which a piston-cylinder unit 3 is inserted in the center. A cylinder 4 is fixed in position in a base 5 of the piston-cylinder unit 3 and is designed for holding a piston 6 displaceable in the cylinder 4. Both the housing 2 and also the piston 6 have a fastening eye 7, 8 by means of which the tensioning system 1 is fixed in the operating state. A compression spring 9 inserted between the base 5 of the housing 2 and the piston 6 generates a spreading force that tensions a belt in a belt drive, for example, in connection with a tensioning roller allocated indirectly to the tensioning system 1 and not shown in FIG. 4. The cylinder 4 and the piston 6 of the piston-cylinder unit 3 define a pressure chamber 10 filled with a hydraulic fluid. For a control motion of the piston 6 in the direction of the arrow, this motion is damped in that a partial quantity of the hydraulic fluid is forced via a leakage gap 11 between a lateral surface of the piston 6 and an inner wall of the cylinder 4 from the pressure chamber 10 into a storage chamber 12 enclosing the piston-cylinder unit 3, according to the arrows arranged in a row. For a control motion of the piston 6 opposite the direction of the arrows, a pressure difference, an underpressure, which allows a reflow of the hydraulic fluid out from the storage chamber 12, is generated in the pressure chamber 10, illustrated by two parallel arrows. For this purpose, a one-way valve arranged on the bottom in the cylinder 4 and designed as a ball valve 13 opens until achieving a pressure equalization between the pressure chamber 10 and the storage chamber 12. As a measure for sealing the storage chamber 12, a bellows seal 25 is provided that is also called a rubber membrane and is fixed on the piston 6 and the housing 2.

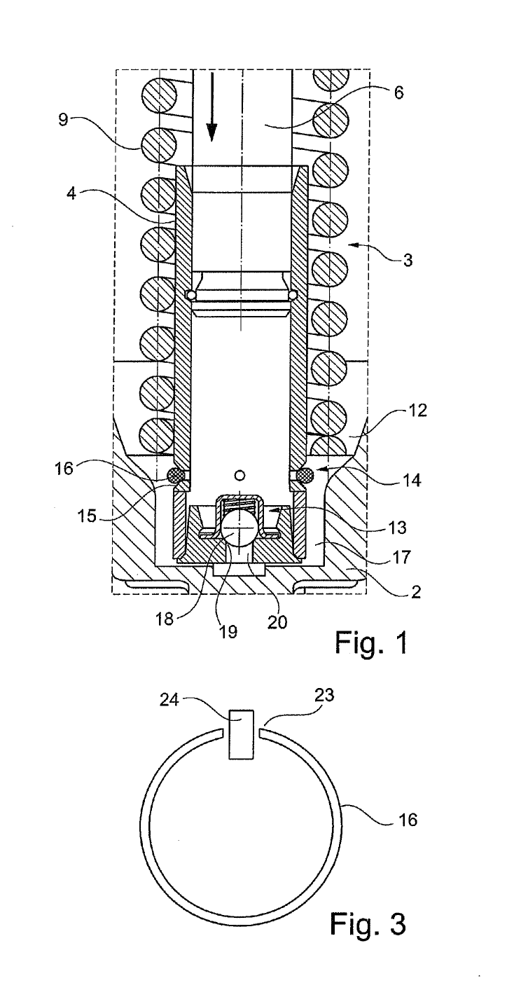

FIG. 1 shows the piston-cylinder unit 3 in an enlarged diagram that corresponds to a large extent to FIG. 4. Deviating from the known solution, the damping of a piston control path in the direction of the arrows is realized via an annular spring valve 14. For this purpose, a peripheral annular groove 15 that is designed for holding a spring element 16 designed as an annular spring is formed in the cylinder 4 on the outside. As soon as a pressure increase in the pressure chamber 10 creates an opening of the annular spring valve 14, the hydraulic fluid flows out from the pressure chamber 10 via an outflow path 17 into the storage chamber 12. For an opposite control motion of the piston 6, the annular spring valve 14 closes and the ball valve 13 opens. Here, a spring-loaded ball 18 lifts from a valve seat 19 and thus allows a reflow of the hydraulic fluid via an inflow path 20 into the pressure chamber 10.

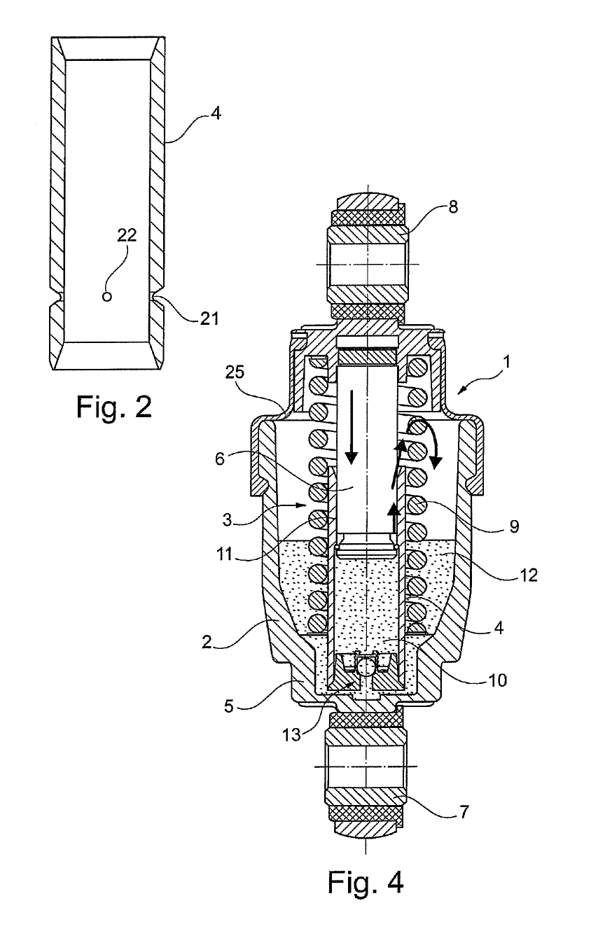

FIG. 2 illustrates the position and design of the annular groove 15 designed for holding the spring element 16 on the lateral surface of the cylinder 4. The V-shaped annular groove 15 generates a centered, positive-fit, and thus sealed contact for the spring element 16. In the cylinder 4, in the area of a groove base 21 of the annular groove 15, several openings 22 are formed that are distributed around the periphery and by means of which, when the annular spring valve 14 is opened, the hydraulic fluid flows out from the pressure chamber 10 via the outflow path 17 into the storage chamber 12.

In FIG. 3, the spring element 16 with a snap joint or slit 23 is shown. As the spring element 16, preferably a radially biased snap ring can be used that is fit in the annular groove 15 in a sealing manner when the annular spring valve 14 is closed. For achieving a position-oriented installation position, a centering tab 24 connected to the housing 2 or the cylinder 4 engages with a positive fit in the slit 23 of the spring element 16.

### LIST OF REFERENCE SYMBOLS

1 Tensioning system
2 Housing
3 Piston-cylinder unit
4 Cylinder
5 Base
6 Piston
7 Fastening eye
8 Fastening eye
9 Compression spring
10 Pressure chamber
11 Leakage gap
12 Storage chamber
13 Ball valve
14 Annular spring valve
15 Annular groove
16 Spring element
17 Outflow path
18 Ball
19 Valve seat
20 Inflow path
21 Groove base
22 Opening
23 Slit
24 Centering tab
25 Bellows seal

1. Hydraulic tensioning system of a belt drive, the system comprising a cylinder having a linear displaceable piston located therein, which together form a piston-cylinder unit and delimit a pressure chamber filled with hydraulic fluid, wherein a relative movement between the piston and the cylinder triggers an exchange of the hydraulic fluid from the pressure chamber into a storage chamber or vice versa, an outflow path is provided for the hydraulic fluid between the pressure chamber in the piston-cylinder unit and the storage chamber, and at least one annular spring valve that opens as a function of pressure is inserted as a one-way valve in the outflow path.

2. Hydraulic tensioning system according to claim 1, wherein for forming the annular spring valve, the cylinder has, in an area of the pressure chamber, at least one opening that interacts with a spring element enclosing an outside of the cylinder and biased in a closing direction over the at least one opening.

3. Hydraulic tensioning system according to claim 2, wherein the cylinder comprises, in one plane, several of the openings that are positioned distributed around a periphery and closed in a neutral position of the piston-cylinder unit by the spring element.

4. Hydraulic tensioning system according to claim 1, further comprising an inflow path for the piston-cylinder unit, and a ball valve is allocated to the inflow path.

5. Hydraulic tensioning system according to claim 2, wherein the cylinder has a V-shaped annular groove on an outside for holding the spring element.

6. Hydraulic tensioning system according to claim 2, wherein the spring element comprises a radially biased snap ring.

7. Hydraulic tensioning system according to claim 6, wherein the spring element is formed from a round spring wire.

8. Hydraulic tensioning system according to claim 2, wherein the at least one opening of the cylinder interacts on an outside with the spring element that is produced from plastic.

9. Hydraulic tensioning system according to claim 5, wherein the outflow path for the hydraulic fluid provides a channel that connects the annular groove of the cylinder to the storage chamber that is defined radially by a housing enclosing the piston-cylinder unit with a spacing and the cylinder of the piston-cylinder unit.

10. Hydraulic tensioning system according to claim 9, wherein a positive-fit positioning is provided between the spring element and the cylinder or the housing.
